(19) United States
(12) Patent Application Publication
(10) Pub. No.: US 2014/0108967 A1
(43) Pub. Date: Apr. 17, 2014

(54) SYSTEM FOR VIEWING AND INTERACTING WITH A VIRTUAL 3-D SCENE

(71) Applicants: Steven Markham, Bushey (GB); Steven Baker, Milton Keynes (GB)

(72) Inventors: Steven Markham, Bushey (GB); Steven Baker, Milton Keynes (GB)

(21) Appl. No.: 14/124,846

(22) PCT Filed: Jun. 8, 2012
(86) PCT No.: PCT/IB2012/052919

§ 371 Date: Dec. 9, 2013

(30) Foreign Application Priority Data
Jun. 8, 2011 (BG) 110990.8

(51) Int. Cl. G06F 3/0481

(52) U.S. Cl. CPC G06F 3/04815
USPC 715/757

(57) ABSTRACT

A system is described for enabling one or more user devices to view and interact with a three-dimensional (3-D) scene. The system comprises a data server 12 having a processor executing a program to create a virtual 3-D scene, and a user device 10 communicating remotely with the data server by way of a wired or wireless network. The user device 10 runs a user interface program for transmitting commands to the data server to modify the virtual 3-D scene and for displaying on a user screen an image that includes image data received from the data server as an encoded stream. The data server 12 is operative additionally to transmit commands to the user device for the purpose of altering the user interface.

### FIELD OF THE INVENTION

The present invention relates to a system for enabling one or more users to view and interact with a three-dimensional (3-D) object or scene without requiring the use of equipment having a high processing capability.

### BACKGROUND OF THE INVENTION

There are several commercial applications in which it would be desirable to display to a user a 3-D scene or a 3-D object over which the user has some degree of control. One such application is in advertising. Car manufacturers, for example, offer models with a wide variety of options such as different colours, trim and wheels, as well as ancillary equipment such as body kits. It would be desirable in this application if a user could assemble a virtual vehicle with all the options under consideration, then view that vehicle from any desired angle.

Certain manufacturers currently allow a user to view a vehicle from all angles. However, this is currently achieved by storing images of the vehicle from all angles. It is not possible for the user to view in this manner a vehicle meeting his own specification as the number of images that would need to be stored to cover all permutations would be impracticable.

There are currently available 3-D design programs that allow an object or scene to be constructed using 3-D vectors and for that object or scene then to be viewed from any desired angle and with variable lighting and rendering. Such programs are used extensively by design engineers in many fields but they are very complex and can only be run on powerful computers.

In the application discussed above, the end user may only have access to a computing device such as a smart phone, a tablet computer, an internet television device, a basic laptop or desktop computer that would not have the processing power to run a 3-D design or modelling program. A further problem is that the software required by the user would need to be specific to the user's computing device and operating system

Another application that allows a user to interact with a 3-D scene is the playing of video games. U.S. Pat. No. 7,849,491 discloses a method and apparatus for allowing a user to play a 3-D video game that requires the user to have a video game box with a game card containing a dedicated processor. Software specific to the game box has to be downloaded by wireless transmission. If two players are to play the same game, they must both use their respective game boxes to create the same 3-D scene on their respective game boxes but moves made by one player area relayed to the other, to enable the scene viewed by each player to take into account the moves of both players.

### OBJECT OF THE INVENTION

The aim of the present invention is to provide a system that allows a user to view and interact with a virtual 3-D scene using unmodified equipment that affords wired or wireless network access and is capable of displaying streamed image data received in a standard format.

### SUMMARY OF THE INVENTION

According to the present invention, there is provided a system for enabling one or more user devices to view and interact with a three-dimensional (3-D) scene, comprising a data server having a processor executing a program to create a virtual 3-D scene, and a user device communicating remotely with the data server by way of a wired or wireless network, wherein the user device is operative to execute a user interface program for transmitting commands to the data server to modify the virtual 3-D scene and for displaying on a user screen an image that includes image data received from the data server as an encoded stream, and wherein the data server is operative to transmit commands to the user device for the purpose of altering the user interface.

The system of the invention requires a bi-directional command link between the user device and the data server for transmitting commands between the user device and the data server in both directions in addition to a data link to enable the data server to stream image data to the user device.

The user interface program component of the system can be implemented by creating a downloadable script which utilises native operating system implementations of HTML5, Javascript or Java, or by creating a compiled program for a third party cross platform technology framework such as Flash, or by creating a native application such as an ‘app’ for a smart phone or an executable for a PC. The user interface program serves to produce commands for the data server based on user input and to display a received image stream on the screen. The user interface can furthermore be modified dynamically by commands received from the data server based on user input or real time updates. The user interface may for example be altered in terms of output (such as information, text or graphics, displayed on the screen, or sounds or lights output by the user device) and/or input (such as key mappings, input gestures, interpretation of mouse or other pointing device inputs, and so on). The user interface may include some form of state machine, for example recording whether the device is in viewing or modification mode, and this state may be altered in response to commands from the data server. Modifications may be made to the user interface in response to such a change of state rather than directly in response to the received commands, for example, such as displaying a different set of menu options, displaying different information, changing key, button, voice and/or command mappings, and so on. In another example, the data server may cause information to be output in response to a selection of a portion of the 3-D scene on the user device, for example displaying a price of a selected component, as well as optionally changing the key or control mapping such that pressing a certain key may carry out a particular action in response to the selection (such as ordering the selected item) or enabling control functions to allow the selection of a different item, for example by pressing a certain key to cycle through related items. Other permutations are of course possible and envisaged within the scope of the invention.

An asymmetric processing capability may exist in the present invention between the data server and user device, because the user interface program requires minimal processing power and can readily run on the processor of the user device. The user can in this way instruct the remote computer to effect changes to the virtual 3-D scene or to view the scene from a different perspective, or to perform complex calculations utilising meta-data from the 3-D scene such as pricing. The modification to the virtual scene will be performed by the processor of the remote data server, which has greater processing power than the user, and the new images generated by the data server will then be relayed back to the user in same way as other streamed still image or video data.

In an embodiment of the invention, the same remote data server may communicate by way of a session server with a plurality of users. In this case, all users will be able to transmit commands to instruct the same data server to modify the 3-D scene, and the scene as modified by all the users will then be available for viewing by each of the users. A separate data stream may be transmitted to each user so that the views seen by the different users may not be the same but they will all be of the same modified scene. Such an embodiment of the invention would for example enable several designers located remotely from one another to make modifications to the same product design and each designer will be able to see the changes made by all the designers.

In another embodiment of the invention suitable for the advertising application discussed above, several data servers may be accessible by one of more users by way of a session server, each data server running a program to generate a different virtual 3-D scene. If for example, two users wish to view a vehicle model, and each wishes to view the model with a different specification, then the two users cannot view the same virtual scene. Instead, the session server will connect each user to a respective data server.

The networks over which the users communicate with the session servers and over which the session servers communicate with the data servers may be wired, wireless or cellular networks and may be intranets or the world wide web. The essence of the invention is that the complex computing required for 3-D design or modelling is performed using what is termed “cloud computing” leaving only a local user interface that requires minimal processing power to generate the screen image and to relay commands to the data server.

It is advantageous for the image displayed to the user not to consist exclusively of the image data received from the data server but to include additional image data generated by the user interface. For example, the displayed image may be divided into a first area where the data stream received from the data server is displayed and a control area for displaying, for example, currently available data server commands or pricing information. The locally generated image data area and the received image data area may be separate areas or overlaid on one another.

Such an implementation offers the advantage, for example, that text data can be computed more rapidly and displayed more clearly by the user hardware, and the system does not place severe demands on the available bandwidth as only the visual data relating to the 3-D scene need be sent as an encoded stream. This embodiment also allows data available to the user to be combined in the display with image data received from the data server.

In a related aspect, the session server permits a plurality of user devices to view and interact with a 3-D scene within a single session. Each user device may for example have different instances of viewing data within the session and/or stored locally such that each user device may view the 3-D scene from an independently controllable viewpoint. Modifications to the 3-D scene are, however, propagated across all user devices belonging to the session. This can, for example, facilitate collaborative design processes with realtime feedback and sharing. The single session may be handled by a single data server such that the user devices may, as before, be connected at the same time to the same data server, but the session may alternatively be distributed across multiple data servers as appropriate and necessary.

In this aspect, the session server may be operative to create a new session including a copy of said 3-D scene, and to transfer at least one of said plurality of user devices to the new session. For example, the session server may be operative, in response to one of said plurality of user devices requesting a modification to said 3-D scene (such as the addition, deletion or modification of a particular object within the scene), to create a new session including an appropriately modified copy of said 3-D scene and, as before, to transfer at least said one of said plurality of user devices to the new session. In this way other user devices originally present in the original session can remain in the session with the original version of the 3-D scene. Thus there can for example be an arbitrary number of versions of a 3-D scene or an arbitrary number of scenes, but allowing the number of sessions to be kept to a minimum (if desired) while also allowing easy modification of the 3-D scene or scenes. It will be appreciated that in a related aspect, user devices can return from a newly created session back to the original session, for example under the control of the user device in question or under the control of a manager or administrator. In this case the newly created session and/or modified version of the 3-D scene associated with the newly created session can be retained, deleted and/or (for example) transferred into the original session, replacing the original 3-D scene. This can for example allow a designer to ‘break out’ of a discussion to make a change to a 3-D scene following feedback from other users and then (for example in response to further feedback on the changed model, which may be given by one or more users joining the new session) either discard or incorporate the change, without requiring in the meantime any alteration of the original 3-D scene being viewed by the other users.

The data server may be operative to make a selection, in dependence on at least one characteristic of the system and for inclusion in the encoded stream (as the image data), of either video image data (of any arbitrary or varying frame rate, in the form of H.264, MPEG, AVI or any other appropriate video format in which successive frames may typically, but not exclusively, be encoded with reference to previous frames) or static image data (such as JPEG, GIF, or any other appropriate static image format, which may typically, but again not exclusively, be encoded independently of any other image or video frame). Video image data is typically encoded so as to have a lower visual quality than static image data for each individual frame, but static image data typically requires a greater file size and therefore bandwidth for a series of equivalent images. Accordingly this feature allows a finer degree of control over the bandwidth used in the system in dependence on any desired characteristic of the system.

This feature is also provided in independent form. Accordingly, there is provided a system for enabling one or more user devices to view and interact with a three-dimensional (3-D) scene, comprising a data server having a processor executing a program to create a virtual 3-D scene, and a user device communicating remotely with the data server by way of a wired or wireless network, wherein the user device is operative to execute a user interface program for transmitting commands to the data server to modify the virtual 3-D scene and for displaying on a user screen an image that includes image data received from the data server as an encoded stream, and wherein the data server is operative to make a selection, in dependence on at least one characteristic of the system and for inclusion in the encoded stream, of either video image data or static image data in the encoded stream.

The characteristic of the system may in particular be the level of usage of the user device. For example, if the user is changing his view of the 3-D scene (or making modifications to it, for example), the data server may in one embodiment send updates in video image format, such that the 3-D scene can be rapidly updated without requiring or consuming excessive bandwidth. In this case the reduced quality of the image is less noticeable because it is constantly changing. In this example, when the user finishes adjusting the view or making changes to the model, and so on, the image data can revert to static, generally higher quality, images, which can be transmitted less often or (for example) only in response to modifications to the view or the 3-D scene. The determination of when to switch between video and static image data may be made in direct response to a command or status update from the user device, or may for example be made by a less direct analysis of data received from the user device—for example deducing that the user is idle or the device is disconnected in the absence of user input for a predetermined time, and so on. The data server may further be operable to vary the bit-rate or bandwidth of the video image data, for example depending on the same or a further characteristic of the system. In another example, the characteristic of the system may relate to the allocation or availability of bandwidth between the data server and the or each user device, such that the data server can switch between video image data and static image data (and also controlling the effective frame rate of either) as required to influence the bandwidth used per device.

In another aspect of the invention there is provided a system for enabling one or more user devices to view and interact with a three-dimensional (3-D) scene, comprising: a plurality of data servers each having computer program code for creating a virtual 3-D scene, and each being operative in an online mode, in which the computer program code is executed, and an offline mode, in which different computer program code is executed; a user device communicating remotely with the data server by way of a wired or wireless network; and a session server for establishing a connection between the user device and one of the data servers, wherein the user device is operative to execute a user interface program for transmitting commands to the data server to modify the virtual 3-D scene and for displaying on a user screen an image that includes image data received from the data server as an encoded stream, and wherein the session server is operative, in response to a request from the user device, to create a session with one of said plurality of data servers that is in an online mode. Thus data servers can be dynamically included within or excluded from the system for providing 3-D image data to user devices, for example allowing the data servers to have up to 100% availability for other tasks, for example under the control of a user of the data server or if a certain condition is detected, such as on detection of a user of the data server going idle. It is understood that dependent features mentioned above may, where appropriate, be combined with this independently provided feature so, for example, there may be multiple user devices per data server and/or a single session can be spread across different data servers, the servers may provide video and/or static image data, and so on.

Preferably the data server and/or session server include computer program code for monitoring use of the data server by the user device, and optionally allowing a user associated with the data server to be given credit for use of the data server by one or more users, for example by billing the users in a flat-rate or metered fashion or by any other appropriate means.

The session server and/or data server may be operative to reassign the user device to a different session and/or data server, for example in the event that the server goes offline (for example because a user resumes use of the data server, causing it no longer to be idle). In the example where data servers become available when the server becomes idle during other tasks, this can help to provide extra computing capacity effectively at no detriment to the user of the data server.

The systems as aforesaid may be provided in the context of multiplayer (or other) gaming. Accordingly, in a further exemplary aspect of the invention there is provided a system for allowing a plurality of users to interact with at least one three-dimensional (3-D) virtual scene in a computer game, the system comprising: a game server having game data relating to the plurality of users; a data server having a game client application for creating said at least one 3-D virtual scene in dependence on game data received from the game server; and a plurality of user devices, each user device being associated with a respective one of the users, and the user devices communicating remotely with the data server by way of a wired or wireless network, wherein the user device is operative to execute a user interface program for transmitting commands to the data server to interact with the virtual 3-D scene and for displaying on a user screen an image that includes image data received from the data server as an encoded stream, and wherein the game client application includes a session manager component for controlling access to the game client application by the plurality of user devices. In a further aspect of the invention, the session manager component may be provided in a separate application or other software component of the data server, or may be provided in a separate server or other component of the system. The game client application may therefore be the same as a game client application suitable for execution on a stand-alone (conventional) computer system. The term ‘application’ may include interpreted or compiled software and may as appropriate extend to plug-ins and other related concepts.

It will be appreciated that subsidiary features relating to one independent aspect of the present invention may where appropriate be applied to other independent aspects, even where not explicitly indicated in the claims. For example, the features relating to the optional session server may fully be applied to the independent aspect relating to the selection of video or still image data (and so on). It will also be appreciated that apparatus and system features may appropriately be provided in method form, for example in the form of a method of providing said features, or in the form of a method of carrying out one or more of the activities implicit in the operation of such features. It will also be appreciated that the data server and user device may be provided independently with appropriate portions of the system as aforesaid.

For example, there may be provided a data server for use in a system for enabling one or more user devices to view and interact with a three-dimensional (3-D) scene, the data server comprising a processor executing a program to create a virtual 3-D scene, and to communicate remotely via a wired or wireless network with and a user device operative to execute a user interface program for transmitting commands to the data server to modify the virtual 3-D scene and for displaying on a user screen an image that includes image data received from the data server as an encoded stream, and wherein the data server is further operative to transmit commands to the user device for the purpose of altering the user interface.

There may also, for example, be provided a user device for use in a system for enabling one or more user devices to view and interact with a three-dimensional (3-D) scene, the user device being operative to communicate remotely via a wired or wireless network with a data server having a processor executing a program to create a virtual 3-D scene, and a user device communicating, wherein the user device is operative to execute a user interface program for transmitting commands to the data server to modify the virtual 3-D scene, for displaying on a user screen an image that includes image data received from the data server as an encoded stream, and for executing commands received from the data server for the purpose of altering the user interface.

Further aspects may be provided as appropriate, for example incorporating the features relating to video and static images.

It will also be appreciated that, unless otherwise stated or being an obviously unworkable configuration, any features described herein (for example in relation to specific embodiments described below) may be incorporated into the present invention independently and (if necessary and/or appropriate) in isolation from any others.

In another aspect there is provided a computer readable medium including computer program code which, when executed on a computing apparatus, causes said computing apparatus to carry out a method as aforesaid (creating the functional equivalent of the system, data server(s) and/or user device(s) as aforesaid). The computer program code as aforesaid may be provided in any other appropriate and tangible form (such as a computer readable signal or encoded onto any general purpose or other computing device or hardware). The computer readable medium may, for example, be a CD, DVD, Blu-ray® disc, or similar, or a hard disk, solid state disk, integrated circuit, and so on.

### BRIEF DESCRIPTION OF THE DRAWINGS

The invention will now be described further, by way of example, with reference to the accompanying drawings, in which:

FIG. 1 is a schematic diagram showing how several users may communicate with several data servers;

FIG. 2 is a block diagram of the processes involved in establishing bi-directional communication between each user and the data server once a session has been initiated by a session server;

FIG. 3 is a schematic of a prior art system for connecting a plurality of user devices to a multiplayer game;

FIG. 4 is a schematic illustrating the interaction between a user device and a prior art multiplayer game system;

FIG. 5 is a schematic illustrating the interaction between a user device, a data server and a multiplayer game server in accordance with one embodiment, and

FIG. 6 is a schematic illustrating the interaction between a plurality of user devices, a data server and a multiplayer game server in accordance with a further embodiment.

### DETAILED DESCRIPTION OF THE PREFERRED EMBODIMENT(S)

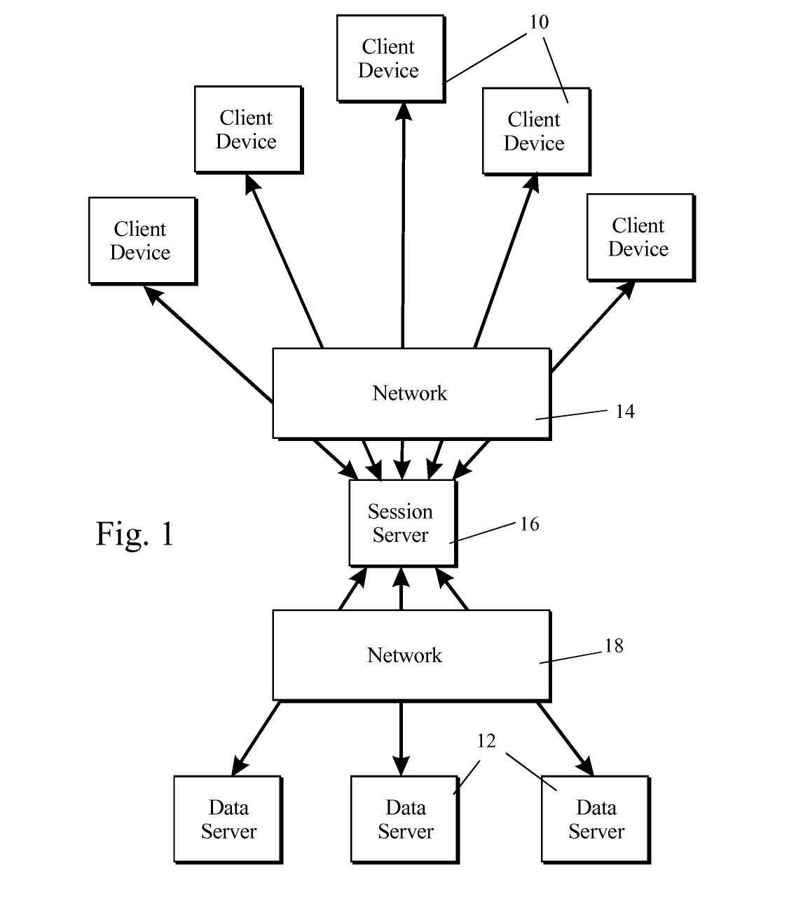

FIG. 1 shows several user or client devices 10 that are capable of accessing a plurality of remote data servers 12. Each user device 10 includes a screen, an input device, such as a keyboard or a touch screen, a screen for displaying images, and a processor of limited capability. A typical use device may be a smart phone, a tablet computer, a mobile or desktop computer, or an internet television, these being devices with insufficient processing power to run a 3-D design or modelling program but capable of running an interface program to be described in greater below. Each data server 12 on the other hand has much greater processing power and may be a main frame computer, a single powerful personal computer or a network of personal computers. Each data server runs a program that generates a virtual 3-D object or scene that can be displayed on screens of the user devices.

Each user device 10 communicates by way of a network 14 with a session server 16, which in turn communicates by way of a network 18 with the data servers 12. Each of the networks 14 and 18 may be a wired, wireless or cellular network. The session server 16 acts in a manner analogous to a telephone exchange to establish a connection between individual user devices 10 and data servers 12. The session server 16 may simply connect each of several user devices to a respective data server 12 but alternatively it may connect several user devices at the same time to a common data server 12. In the latter case, the same 3-D virtual scene on the data server 12 will be available for each of the user devices to view and optionally to modify.

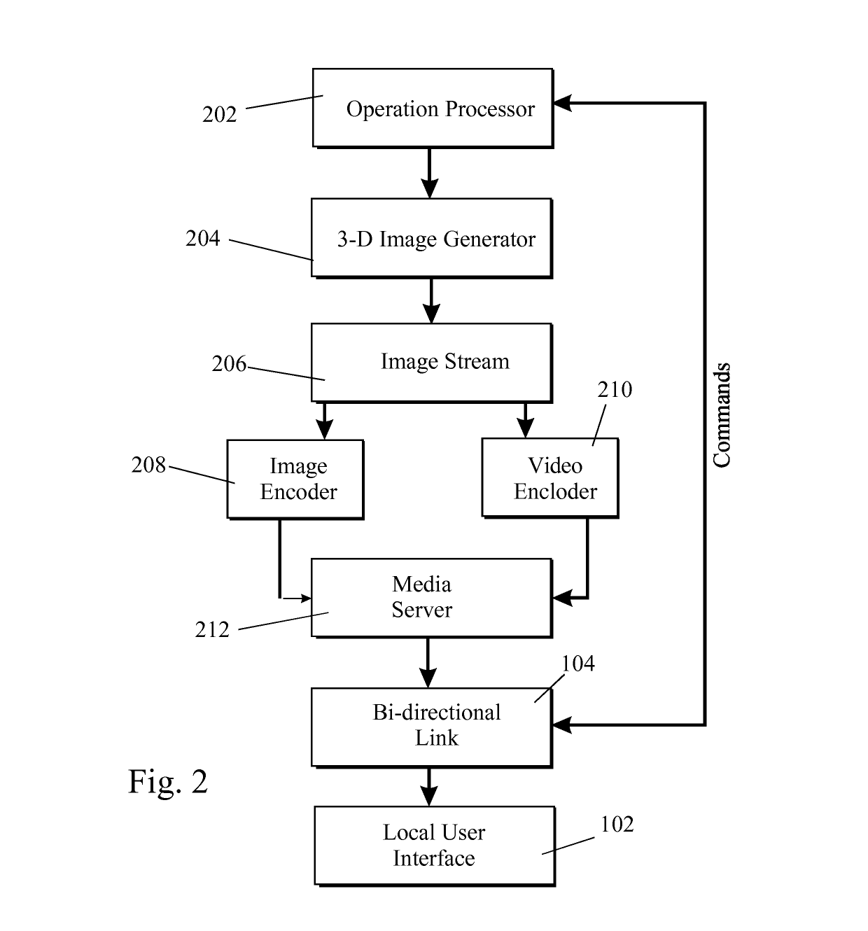

Referring now to FIG. 2, the blocks in the 100 series are connected with the user device and those in the 200 series are connected with the data server.

Starting with the user device, this comprises only a local user interface 102 and a bi-directional link 104. The local user interface is used to display on the user screen image data received via the bi-directional link 104. The local user interface also displays on the screen, under control of the data server, commands that are available to the user for interacting with the program running on the data server. If, for example, the user wishes to view the virtual object or scene from a different angle or to render it differently, the instructions for doing so will be displayed to the user by the user interface. To this end, the user interface program is itself modified by commands received from the remote data server 12. The user interface component can further be modified to include updates.

In addition, the local user interface 102 may be used to process locally stored data and to display the results on the screen.

Turning now to the data server, the commands entered by the user are transmitted via the bi-directional link 104 to an operation processor 202. The processor 202, in addition to running a program to generate a virtual 3-D object or scene, transmits commands to vary the user interface 102 as mentioned above. Images of the 3-D object or scene, which may if desired include a sound track, are generated by a 3-D image generator 204 and converted into an image stream 206 that is relayed by image and video encoders (including audio) 208 and 210 and a media server 212 back to the user device over the same bi-directional link 104.

In order to minimise bandwidth requirements, the processing required to display an image on the user screen is divided between the local user interface 102 and the operation processor 202. In general, it is preferred to use the media server to transmit only image information relating to the virtual 3-D object or scene. The layout of the image data on the screen and any text displayed alongside the image data is best computed locally. Thus, by dynamically modifying the user interface based on user input instead of constantly refreshing the image data, it is possible to make optimum use of the available bandwidth.

The user interface may be a smart phone app or a small executable program that is platform specific. The program, which may be downloaded from the internet, includes the software necessary to display the received image stream data. The interface program is modifiable by commands received from the data server to control the image layout and to display additional data alongside the image of virtual 3-D object or scene. The commands to modify the interface need not be platform specific so that once the initial software has been downloaded and run on the user device, the same commands may be sent to all users to modify the interface dynamically.

An important application of the invention is to permit “cloud computing”. A user without the necessary hardware and software to perform 3-D design, is capable of doing so by taking advantage of the processing power available in a remotely located computer.

The same data server may be connected by the session server 16 to communicate with several user devices 10 at the same time. In this case, all user devices will be able to transmit commands to instruct the same data server to modify the 3-D scene, and the scene as modified by all the users will then be available for viewing by each of the users. A separate data stream may be transmitted to each user so that the views seen by the different users may not be the same but they will all be of the same modified scene. In this way, the invention can allow several designers located remotely from one another to make modifications to the same product design while allowing each designer to see the changes made by all the designers.

In normal operation, the data server is kept informed of the status of the user device using ‘keep alive’ and ‘idle’ commands sent from the user device. When the user is engaged in an operation, such as rotating, panning, zooming and so on, the 3-D scene is updated with a high refresh rate using video image encoding. Each frame has a relatively low image quality but the overall effect is a smooth animation of the scene. Once it is detected that the current operation has finished, for example by an ‘idle’ command sent from the user device, a static image is sent to replace the last frame of the video image. The bandwidth required to send a static frame is larger than that required to send a frame of video, but in this case only one image is sent, providing a high quality display, and the bandwidth for that user device is then minimised while the user is idle, making it easier to serve multiple devices at once. The bitrate and/or frame rate of the video (and quality of the image) is also adjustable, for example to allow continued operated albeit at reduced quality when the bandwidth is limited.

The user devices may typically have ‘view’ and ‘modify’ modes in which the options available to the user vary. With the present system, these options are not required to be hard-coded by the viewing application, but can be dictated by the server and transmitted as the above-mentioned commands. Other modes are of course possible.

Typical commands available (via keyboard input, finger gestures, mouse movements, trackball movements, and so on) in the ‘viewing’ mode include Pan Up/Down/Left/Right, Tilt Up/Down/Left/Right, Roll Up/Down/Left/Right, Zoom In, Zoom Out, FOV (Field Of View) Wider, FOV Smaller, and so on. Typical commands in the ‘edit’ mode include Add, Delete, Resize, Select, and so on. Access to different modes and/or access to specific commands within each mode or otherwise can be controlled with an appropriate access model, for example requiring authentication of users or user devices to grant administrative or management access.

In an example of an interaction between the user device and data server, the user could press on a touchscreen, causing a Select command to be sent to the data server with a screen coordinate (x,y). The data server can then translate the command into a point in 3D space and/or object or sub-object. In one example the server can transmit a command back to the user device to highlight the relevant object and to display in a separate area information about the object, such as a characteristic of the object (material type, name, price, order in object hierarchy, and so on). A further command could for example be sent to remap the keyboard or other controls such that a particular key (and so on) causes the selection of an immediately preceding or following object.

In a related embodiment (not shown) the data servers are not (wholly) dedicated hardware for the present task, but may for example include home computers or office computers and the like, which can be made available for the present task when they are idle or during preassigned times, and so on. A central session server coordinates with the ‘part time’ servers, for example exchanging messages to determine when the servers are online or offline. When a server is online it can accept a connection with a user device and perform a function as described above. When the data server goes offline (for example if a user returns to use it, a time period expires, or there is a network fault, and so on), the session server automatically reroutes the user device to an alternative data server. Session data may be wholly or partly stored at the session server, allowing such a transfer without further input from the former data server, for example. Access to the data servers can be metered or otherwise charged so that the user of the data server (home PC or otherwise) can be given an incentive to contribute to the scheme. Such metering or billing can be handled by the session server or another server dedicated to the purpose, for example. It will be appreciated that a number of billing schemes can be adapted for the present embodiment.

A further embodiment will be described below with particular application to multiplayer game systems, including for example massively multiplayer online role playing games (MMORPGs) and the like.

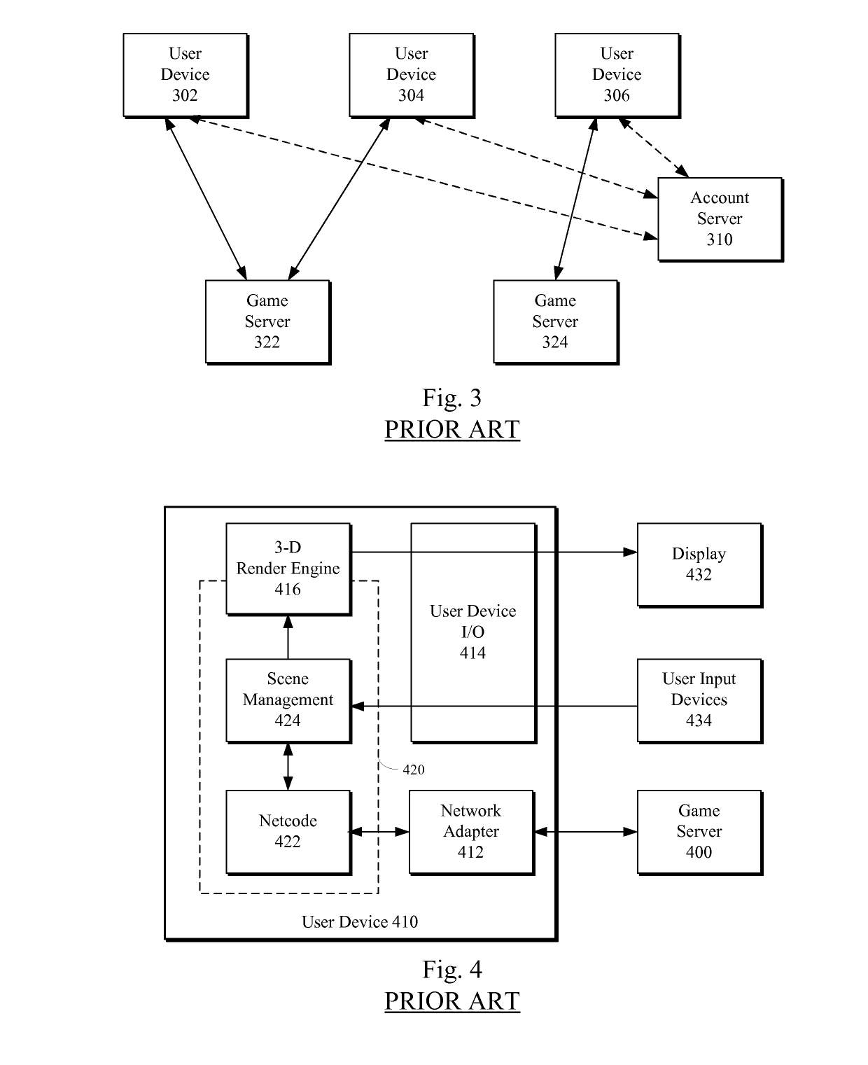

First a brief explanation will be given, with reference to FIGS. 3 and 4, of existing multiplayer game systems.

FIG. 3, first of all, is a schematic of a prior art system for connecting a plurality of user devices to a multiplayer game. In FIG. 3, a plurality of user devices 302, 304, 306 are shown, in communication with an account server 310 and a plurality of game servers 322, 324. Typically a multiplayer game comprises a server component (not shown) executing on the game servers 322, 324, and a client application (not shown) executing on the user devices 302, 304, 306 which initially communicates with the account server 310 for authentication and/or other purposes. Typically the account server 310 may provide a list of game servers 322, 324, to which the user devices 302, 304, 306 may then connect, normally using one-to-one sessions with one session per client application. It should be noted that the present embodiment is not limited to multiple game servers and is equally applicable to multiplayer games having only a single game server and optionally no account server.

FIG. 4 is a schematic illustrating the interaction between a user device and a prior art multiplayer game system in more detail. The game server 400 and a user device 410 (which may be one of the user devices from FIG. 3, for example) are shown. The user device 410 comprises a number of hardware elements, including a network adapter 412, user device input/output section 414 and a 3-D render engine 416 (provided as part of the motherboard or as a separate graphics card, for example). The user device 410 also comprises a number of software components, including operating system (not shown), and various applications (not shown) in addition to the multiplayer game client application 420. The game client application 420 includes network code 422 for managing the communication and synchronisation with the game server 400, and a scene management component 424, as well as possibly other, related software components which are omitted from FIG. 4 for clarity. The 3-D render engine 416 may be partly implemented in software, and to an appropriate degree implemented as part of the game client application 420. The application may for example communicate with the render hardware using DirectX®, OpenGL® or other graphics protocols. The game client 420 receives input from the user via user input devices 434 (via the hardware I/O 414) and the 3-D scene is displayed to the user via an appropriate display 432 (again via the hardware I/O, which may be part of a graphics card, if present).

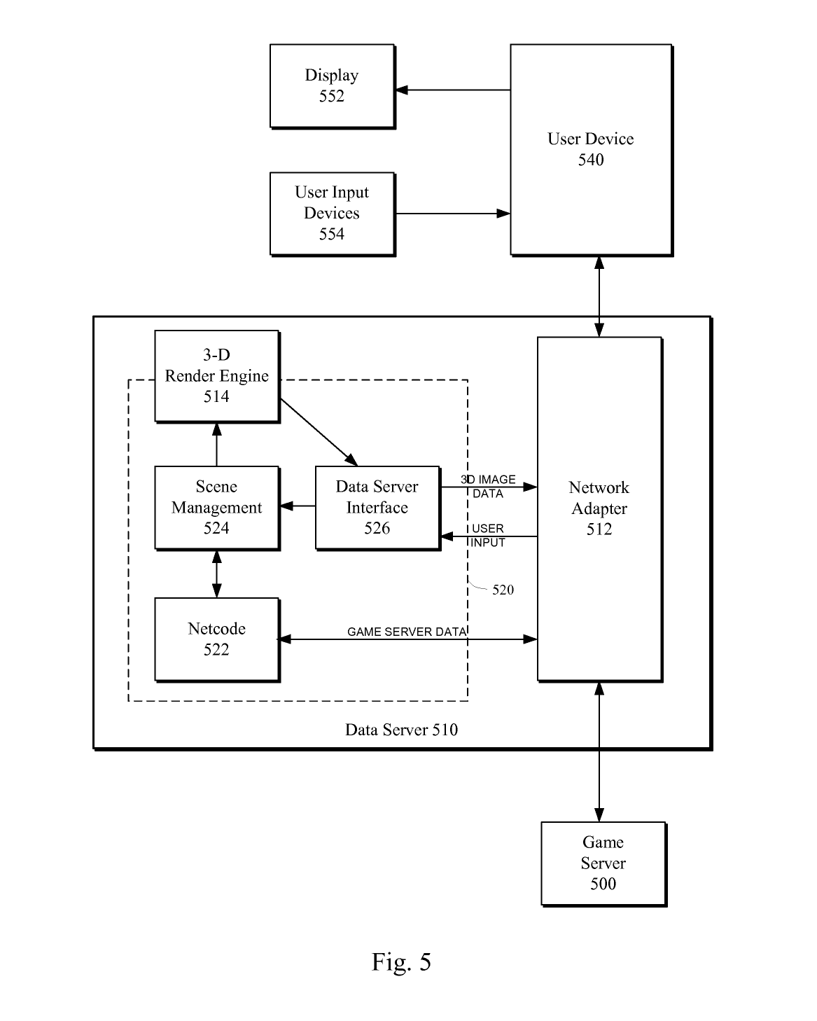

Turning now to the present embodiment, FIG. 5 is a schematic illustrating the interaction between a user device, a data server and a multiplayer game server in accordance with one embodiment. In more detail, a game server 500, data server 510 and user device 540 are shown. The game server, data server and user device are interconnected by any appropriate link, such as one or more networks, for example. To reduce latency, the data server 510 may be located in close proximity to the game server 500 and may for example be connected by a local area network (LAN), whereas the user device 540 is more typically connected to the data server 510 via a wide area network (WAN) such as the Internet.

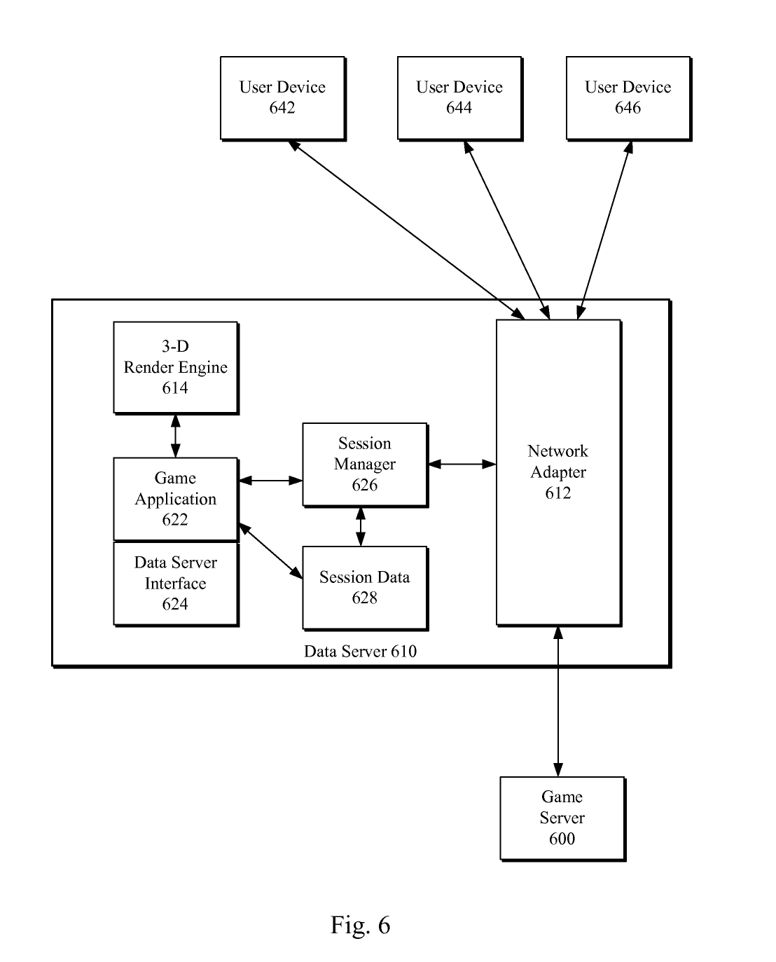

The data server 510 includes, as before, hardware components such as a network adapter 512 and 3-D render engine 514 which may, as before, be implemented partly or indeed wholly in software. A software application 520 is shown, corresponding largely though (in the present embodiment) not identically to the game client 420 of FIG. 4. The application 520 includes the netcode 522 and scene management 524 components of the game client as well as optionally additional 3-D render engine and any other appropriate software components. The application 520 also includes a data server interface component 526 which fulfils essentially the same function of the data server 12 of FIG. 1 as described above, and in particular transmits 3-D scene image data to the user device 540 for display on its associated display 552, also receiving commands, which may for example be transmitted in response to user input received via user input devices 554 associated with the user device. The 3D image data and user input are routed to/from the user device and the application 520 via the network adapter 512 of the data server 510. Though components of the data server 510 are described here in relation to the embodiment of FIGS. 5 and 6, it will be appreciated that appropriate features of the data server 510 may also be provided in the above-described embodiment of FIG. 1 and FIG. 2.

It will be appreciated that the data server 510 represents a minimal modification of the conventional user device 410 of FIG. 4. In the present embodiment an essentially minor modification has been made to the game client 420 of FIG. 4 in order to allow the game to be played at a remote user device 540. Because the data server interface 526 is integrated with the game client, it is possible to provide multiple client sessions in the same application 520. In a variant, virtual ports and/or other forms of input/output redirection can be provided to allow an essentially unmodified version of the game client to run on the data server 510. This can make it easier to implement the server, but the downside is that typically additional copies of the game client 420 will need to be executed for each additional client served by the server 510, and this usually results in very poor server performance because of reduplication of effort and contention for resources by multiple game clients (which are normally coded with the presumption that they will have sole control of the host machine).

FIG. 6 is a schematic illustrating the interaction between a plurality of user devices, a data server and a multiplayer game server in accordance with a further embodiment. This is an alternative view of the system of FIG. 5, additionally showing a session manager component which may also be present (but not shown) in the system of FIG. 5. In FIG. 6 a game server 600, data server 610 and plurality of user devices 642, 644, 646 are shown. The data server includes a network adapter 612 and 3-D render engine 614, and software components including a game application 622 twinned with a data server interface 624 as previously described, a session manager 626 and (optionally) a session data repository 628. The session manager may communicate directly with user devices 642, 644, 646 or via an intermediary session server as described above (in which case cooperating with the session server to provide the required functionality as described above). In essence the session manager facilitates the creation of different instances of the game client (with common code and other elements) as required and as appropriate. It will be appreciated that single-player and other games not requiring the use of a game server may also be provided, essentially by omitting the game server 600 from the system.

One use of the system described above is to provide access to games (whether multiplayer or otherwise) to user devices which may not otherwise be capable of running the games (due to hardware constraints relating to graphics or otherwise, or due to lack of compatibility, and so on). Another use of the system is to decentralise games systems, eliminating the need to have a centralised server farm in a data centre, for example.

The system described above can also serve to mitigate or even out problems relating to latency or ‘lag’, as is explained below.

In a typical single-player game, rendering and game event processing takes place at a fraction of a second and essentially the only latency for reaction time t=rendering time+game processing+user input time.

However when a game is played with multiple players over a network the trip time between players and the server complicates the processing of events such that predictions and corrections must be made about the state of the world at time t+(trip time) and the time required to react to events by another user is at least t1+(trip time 1)+t2+(trip time 2), trip time (also known as ping time or transit time) being amount of time required for a packet of data to travel between a client and server.

In more detail, in a standard model with user A, user B and server X:
The time taken from user A to server X=ping time A, and
The time taken from user B to server X=ping time B
The time taken for user B to see an event initiated by user A=ping time A+server processing time+ping time B+render time B
The time taken for user A to see an event initiated by user B reacting to event initiated by user A=ping time A+server X event processing time+ping time B+render time B+user reaction time B+ping time B+server X event processing time+ping time A+render time A

In this system the client machine must make assumptions on how the server representation of the game world has changed during the transit time of data from server to client and the server may have to make assumptions based on the transit time of data from client to server.

By contrast, in a model using the data server arrangement described above with user A, user B and server X:
The time taken from user A to server X=ping time A
The time taken from user B to server X=ping time B
The time taken for user B to see an event initiated by user A=ping time A+server processing time+server rendering time+ping time B
The time taken for user A to see event initiated by user B reacting to event initiated by user A=ping time A+server X event processing time+server X render time+ping time B+user reaction time B+ping time B+server X event processing time+server X render time+ping time A

In this model, all event processing takes place on the central server which means there is effectively zero latency for all clients during event processing and therefore no possibility of a mismatch between client and server game world representations, and no assumptions are required on how the game world may change as there is no transit time required between updating the game world and rendering the game world visually which means rendering will take place ‘ping time’ seconds earlier than in the standard model.

Also because the client does not process any game event information there is also no possibility of ‘cheating’ or ‘hacking’ the game client to provide unfair advantages which other users do not have available to them.

It will be appreciated that further modifications may be made to the invention, where appropriate, within the spirit and scope of the claims.

1. A system for enabling one or more user devices to view and interact with a three-dimensional (3-D) scene, comprising a data server having a processor executing a program to create a virtual 3-D scene, and a user device communicating remotely with the data server by way of a wired or wireless network, wherein the user device is operative to execute a user interface program for transmitting commands to the data server to modify the virtual 3-D scene and for displaying on a user screen an image that includes image data received from the data server as an encoded stream, and wherein the data server is operative to transmit commands to the user device for the purpose of altering the user interface.

2. A system as claimed in claim 1, wherein the user interface serves to produce commands for the data server based on user input and to display a received image stream on the screen.

3. A system as claimed in claim 2, wherein the user interface is operative to display image data generated by the user device alongside image data received from the data server.

4. A system as claimed in claim 1, wherein the user device communicates with the data server by way of a session server.

5. A system as claimed in claim 4 wherein the session server permits a plurality of user devices to be connected at the same time to the same data server.

6. A system as claimed in claim 4, wherein the session server permits a plurality of user devices to view and interact with a 3-D scene within a single session.

7. A system as claimed in claim 6, wherein the session server is operative to create a new session including a copy of said 3-D scene, and to transfer at least one of said plurality of user devices to the new session.

8. A system as claimed in claim 1, wherein the data server is operative to make a selection, in dependence on at least one characteristic of the system and for inclusion in the encoded stream, of either video image data or static image data.

9. A system for enabling one or more user devices to view and interact with a three-dimensional (3-D) scene, comprising a data server having a processor executing a program to create a virtual 3-D scene, and a user device communicating remotely with the data server by way of a wired or wireless network, wherein the user device is operative to execute a user interface program for transmitting commands to the data server to modify the virtual 3-D scene and for displaying on a user screen an image that includes image data received from the data server as an encoded stream, and wherein the data server is operative to make a selection, in dependence on at least one characteristic of the system and for inclusion in the encoded stream, of either video image data or static image data in the encoded stream.

10. A system as claimed in claim 8, wherein the characteristic of the system is the level of usage of the user device.

11. A system for enabling one or more user devices to view and interact with a three-dimensional (3-D) scene, comprising:
a plurality of data servers each having computer program code for creating a virtual 3-D scene, and each being operative in an online mode, in which the computer program code is executed, and an offline mode, in which different computer program code is executed;
a user device communicating remotely with the data server by way of a wired or wireless network; and
a session server for establishing a connection between the user device and one of the data servers,
wherein the user device is operative to execute a user interface program for transmitting commands to the data server to modify the virtual 3-D scene and for displaying on a user screen an image that includes image data received from the data server as an encoded stream, and wherein the session server is operative, in response to a request from the user device, to create a session with one of said plurality of data servers that is in an online mode.

12. A system for allowing a plurality of users to interact with at least one three-dimensional (3-D) virtual scene in a computer game, the system comprising:
a game server having game data relating to the plurality of users;
a data server having a game client application for creating said at least one 3-D virtual scene in dependence on game data received from the game server; and
a plurality of user devices, each user device being associated with a respective one of the users, and the user devices communicating remotely with the data server by way of a wired or wireless network,
wherein the user device is operative to execute a user interface program for transmitting commands to the data server to interact with the virtual 3-D scene and for displaying on a user screen an image that includes image data received from the data server as an encoded stream, and
wherein the game client application includes a session manager component for controlling access to the game client application by the plurality of user devices.
